(19) United States
(12) Patent Application Publication
(10) Pub. No.: US 2023/0149990 A1
(43) Pub. Date: May 18, 2023

(54) BODY PROCESSING APPARATUS AND METHODS OF USE

(71) Applicant: JA & JB BOYLE PTY LTD, Proserpine, QLD (AU)

(72) Inventor: Jeffrey Allan BOYLE, Proserpine (AU)

(21) Appl. No.: 18/016,446

(22) PCT Filed: Jul. 15, 2021
(86) PCT No.: PCT/AU2021/050761

§ 371 Date: Jan. 16, 2023

(30) Foreign Application Priority Data
Jul. 15, 2020 (AU) 2020902449

(51) Int. Cl. B09B 3/70

(52) U.S. Cl. CPC B09B 3/70

(57) ABSTRACT

The invention relates to body processing apparatus including a first water tank and a body processing chamber, in fluid connection, and adapted to receive a dead body. An additive treatment means is included to add to the body processing chamber or to the water used, during the process. At least one second water tank is included for receiving water from 5 the body processing chamber, through a fluid connection therewith, and also a water cleaning system, in fluid connection with the second water tank. The body is placed within the body treatment chamber, additives are added, water enters from the first water tank and processing occurs until the body breaks down, after which the water is drained to the second water tank and enters the water cleaning system for cleaning. The invention also 10 relates to variants thereon and methods of use.

### FIELD OF THE INVENTION

The present invention relates to a body processing apparatus using alkaline hydrolysis.

### BACKGROUND OF THE INVENTION

When a person dies, the family has a limited choice, to bury the body, to cremate the body, or make some other personal arrangement according to the laws and customs of the country where the death took place. Increasingly, cremation is favoured by families as more suited to their needs. There are many factors for a family to consider, the wishes of the deceased person, religion, and the type of gathering that may be organised for the family to attend. Practical factors such as the geographical location of the body, relative to the family, and the cost to bring about the cremation or burial about must also be considered. The option of an environmentally friendly, economic way to respectfully process the body of a deceased person has long been sought.

Some simple systems of using water and potassium to process the body are known, but these produce a water solution containing the broken down body tissues, that must be disposed of safely. Further, a considerable amount of energy and water must be used in order that the body can be processed in these known systems.

The inventor has developed a body processing system, that is a surprising improvement over the prior art, that can be fully self-contained, recycles the water and has a low carbon foot print through use of solar heating. In its most preferred form, the water produced from the alkaline hydrolysis is filtered to crystal clear water that may be recycled, reducing the water usage of the system. Thoughtful inclusions include the possibility to use some of the untreated water and body constituents to provide nutrient to a bush or tree as an enduring memento for the family. The remaining bones are further dried and processed and also returned to the family. In the most preferred form of the invention, the body processing is an environmentally friendly system that uses rain water, recycled water and solar power to achieve the processing of the body including a sophisticated filtration and water cleaning system. As detailed in the preferred embodiment, the system has been considered in all its aspects to satisfactorily process the body, provide a suitable memento to the family, including the urn of dried bones and the bush or tree to be grown using some of the nutrient derived from the body of the family member, in an environmentally friendly manner. The invention gives a truly environmentally friendly choice to a family that is also thoughtful and respectful.

It is anticipated that the novel and inventive method of body processing described herein will be very well received by families looking for a better choice for the processing of the deceased person. This clever invention is also likely to be well received by the industry, as it develops the method of alkaline hydrolysis through use of water and Potassium Hydroxide to process a body efficiently, gently to a truly useful and environmentally friendly method, that can be put into use straight-away.

The following describes a non-limiting example of the invention being used with reference to processing of a dead human body. The invention is a highly appropriate and useful manner of processing for human bodies after death. However, the invention may likewise be used for processing of deceased animals, including pets. The invention may be used for any animal, not limited to human bodies or pets, where it is desired to use the treatment to resolve the animal to bones and water solution, for example

For clarity, any prior art referred to herein, does not constitute an admission that the prior art forms part of the common general knowledge, in Australia or elsewhere.

It is an object of the present invention to provide a body processing method that at least ameliorates one or more of the aforementioned problems of the prior art. It is a further and separate object of the present invention to provide a method of body processing that at least ameliorates one or more of the aforementioned problems of the prior art.

### DISCLOSURE OF THE INVENTION

Accordingly, the present invention provides, a body processing apparatus for treating a dead human body, the body processing apparatus including:
at least one first water tank for holding water;
a body processing chamber, for processing the human body by alkaline hydrolysis, the body processing chamber adapted to receive the dead body, and in fluid connection with the first water tank, able to receive water therefrom;
an additive treatment means, whereby necessary additives are added to the body processing chamber or to the water used, during the process, and the additive does not distribute until the water enters the chamber;
at least one second water tank for receiving water from the body processing chamber, through a fluid connection therewith and holding the resultant nutrient and water solution; and
a water cleaning system, in fluid connection with the second water tank to separate the nutrient and water and including a physical filtration system to thoroughly clean the processing water before recycling the substantially clean water, either recirculating within the body processing apparatus, or for another purpose,
   wherein, the human body is placed within the body treatment chamber for alkaline hydrolysis processing, additives are added through use of the additive treatment means, water enters from the first water tank and processing occurs until the body breaks down, after which the water is drained to the second water tank, and enters the water cleaning system for a thorough cleaning, including being treated to substantially return the water to substantially pH neutral or approximately 7.2, ready for recycling or recirculation.

Accordingly, the invention also provides in another form a body processing apparatus for treating a dead body, the body processing apparatus including:
at least one first water tank for holding water;
a body processing chamber, the body processing chamber adapted to receive the dead body, and in fluid connection with the first water tank, able to receive water therefrom;
an additive treatment means, whereby necessary additives may be added to the body processing chamber or to the water used, during the process;
at least one second water tank for receiving water from the body processing chamber, through a fluid connection therewith; and
a water cleaning system, in fluid connection with the second water tank,
   wherein, the body is placed within the body treatment chamber, additives are added through use of the additive treatment means, water enters from the first water tank and processing occurs until the body breaks down, after which the water is drained to the second water tank and enters the water cleaning system for cleaning.

Preferably, the body is a human body of a deceased person. The body may be an animal body. The body may be the body of a pet. It is possible that more than one body could be processed using a similar system, configured to process more material at the same time—for example a family. However, in most societies it is preferred to process a single body, through use of the invention.

Preferably, the processing is the processing of a deceased body as an alternative to burial or cremation. That is the processing is the final treatment of the body so as to prevent decomposition of the soft tissues as would otherwise occur. Any suitable processing may be included for the body, during use of the apparatus.

A control may be included with a control panel for computerised control of the apparatus. Some parts of the apparatus may be manually controlled. Some parts of the apparatus may be computer controlled. Some parts of the apparatus may be controlled through use of manual control or the control panel. The control panel includes a microprocessor and monitor in the usual manner to actuate on off controls as required. Preferably, a Programmable Logic Controller (“PLC”) is included, to enable control of the features of the system to be programmed. A display monitor is preferably included. The movement of parts of the apparatus may be controlled through the control panel. The flow of water to different parts of the apparatus may be controlled from the control, and use of the control panel. Valves or similar may be used to open or close flow of water from one area to another, as required.

The apparatus as described is very useful for processing a body in an environmentally friendly and cost-effective manner. Other apparatus may be combined with the apparatus described. For example, a solar power system to provide power may be included. A solar water heater system may be included to provide hot water. A pump system may be included to assist to move the water around the apparatus. One or more pump may be included to provide movement of water from one area to another as required throughout the system, as would be understood by the person skilled in the art. Preferably, water from the first tank can be used in a solar water heating system and heated before use for body processing in the chamber. An irrigation system could be linked to the apparatus to make use of excess water in the system in some uses. A cremulator may be associated with the apparatus for use to further dry and process or powder the bones suitable to be returned to the family in an urn, for example.

There may be any number of first water tanks. Preferably, a first water tank includes a clean water tank for supply of clean water to the body processing chamber. In other forms of the invention the water for processing may be provided through any suitable means. The first water tank may be omitted. The water used for processing may come direct from the first water tank or via other tanks or means. For example, clean water may be used from the clean water tank in an associated hot water system before the hot water enters the chamber for processing. Preferably, the clean water tank is associated with a solar hot water system to heat the water before it enters the tank for processing. A counter, such as a litre counter may be included before the water enters the chamber to measure the water volume entering the chamber. The water volume entering the chamber may be measure or controlled through use of suitable measures and the control system. Where the water is entering the chamber from a solar water heating system the volume of water may be measured using a litre counter or similar. A similar volume of water to that used to enter the chamber may be caused to enter the system or enter the hot water system in some more automated forms of the invention.

The clean water tank may have a capacity of around 600 litres. The clean water tank may be filled through any suitable means. Most preferably, cleaned water from the system can be returned to the clean water tank for use in future processing. Preferably, a rain water tank is included. Preferably, the rain water tank has a capacity of around 5000 litres. In some forms of the invention the rain water tank is the clean water tank. Optionally rain water or recycled water may be chosen for use in processing. Most preferably, a rain water tank is included to supply water to the clean water tank for use for processing. A roof collection system may be incorporated to collect rain water for the process. In some forms of the invention the first water tanks may be omitted and a direct water supply may be used. However, the recycling element of the invention is much preferred and therefore at least one tank will be included. Most preferably, rain water is collected and stored in a rain water tank and may be directed into the clean water tank for use in processing as required. Any suitable funnels, pipes and other parts of the rain water collection system may be used.

The tank may be made of any suitable material. The tank may be made of a material chosen from the following group: composite material; engineered material; metal; plastics and recycled materials. The or each tank may be the same or different to one another. The size of the tank may be chosen from the group: 400; 500; 600; 700; 800; 900; 1000; 1200; 1500; 3000; 4000; 5000; or larger litre volume tank. Preferably, the tank holds water ready for use but may include a tap and or overflow as required. Preferably, a clean water tank of substantially 600 litres is included. Preferably, a large rain water tank is included. Preferably, the rain water tank is a substantially 5000 litres tank. Standard pipes, valves may be included as required at any stage of the water flow. Further tanks and off-takes may be included in the system.

Preferably, the clean water tank is in fluid connection to a pump to pump clean water into a solar heating system for heating before use in the chamber for body processing. The solar heating system may include one or more solar heating elements to heat water. The water may be heated direct through a series of pipes or through use of solar power. A combination of solar powered heating may be provide in some forms of the invention. A mains power attachment may be included as a back up or optional supplementary heating for cool cloudy days. Preferably, the pump is under the control system control. A manual control may be used to cause the clean water to be pumped from the clean water tank into a solar heating system. Alternative heating systems may be used.

Pumps, valves, and pipes are used throughout the system and there may be intermediary tanks, pumps, valves or pipes at any point in the system as would be understood by the person skilled in the art. Preferably, the control system uses electrical controls to open and close the valves to move water through the system.

Preferably, water is pumped from the clean water tank to the solar heating system for heating before being caused to enter the vessel under control of the control system. Preferably, a litre counter or similar volume counter is included to measure the volume of the water entering the chamber. Preferably, the volume of water entering the chamber can be measured and or monitored and adjusted through use of the control system. The water volume that enters the chamber may be predetermined by the control system and once the litre counter records the set value the appropriate valve is closed and no further water enters the chamber. Preferably, at least 300 litres of water is counted into the chamber for processing. Preferably, at least 150 litres of hot water and potassium are introduced into the chamber for processing. The hot water may be maintained at substantially 80 degrees Celsius. The temperature and processing may be maintained for substantially 10 hours. In one preferred form as the water cools to substantially 50 degrees. After cooling the water may be processed, part of the water cleaning process. An oil separator may be included. An oil separator and gravity fall may be used to remove oil products from the water, before further cleaning. The collected oil may be treated with an enzyme to break it down completely. Preferably, a flocculant is used to accelerate separation of the suspended solids from the water. The flocculant may be used in a separate tank. Any suitable flocculant may be used. Preferably, the flocculant is used over time, optionally 3 hours, before being released to gravity feed to a 5-micron filter bag. Other suitable bag filters may be used. Further filters may be used, including carbon filters. Multiple filters may be used to clean the water. The carbon filter may remove residual discolouration or odour.

Preferably, multiple stages of water cleaning are used to result that each body is processed individually in clean water, and produces water suitable for recycling or recirculation.

At any stage of the water cleaning any suitable physical filter may be used. The physical filter may be a carbon filter. The physical filter may include a flocculant and filter to collect and separate suspended particulates.

Other suitable pumps, valves, controls or intermediary steps may be included on the clean water side of processing to move the clean water before processing.

The body processing chamber may take any suitable form, a vessel to contain and process the body. The body processing chamber may be a generally cylindrical body, suitable to receive a body. Preferably, the body processing chamber is of a size and shape suitable to accommodate most body sizes and shapes. Preferably, the body processing chamber is of an approximate size of 2400 millimetres by 840 millimetres. Preferably, the chamber is sealable so as to contain water. Preferably, the seal is strong, to make the chamber water tight. Preferably, the seal is suitable for use with hot water. Preferably, the seal is suitable for use with high pH solution. The door seal may include one or more sealing elements and a tight closure to compress these and maintain the seal. Preferably, a rotating wheel handle seal is used to ensure reliable sealing of the door every time. There maybe multiple sections or areas to the chamber, at least one of which is sealable during processing.

Preferably, the body processing chamber includes means to put the body in and out easily. The means may be sliding on rails. There may be means included to assist the sliding of the rails, for example TEFLON (Trade Mark) coated rails and runners may be used. The body processing chamber may include a body basket into which the body is placed. Preferably, at least part of the body processing chamber may be moved in or out of the chamber. Most preferably a sliding rail system is usable to move part of the body processing chamber in and out to facilitate the putting of the body into the chamber. An actuator may be included to control the movement of the body basket on the rails between and out and in position. Most preferably, a body basket is included and the body basket can be slid in and out on rails to enable the body to be placed inside. In a most preferred form the basket may be divided into individual baskets. There may be 5 basket divisions. The individual baskets may be able to be removed individually after processing to assist in removal of any materials remaining.

Preferably, the body processing chamber may be water sealed after the body has been placed inside. Preferably, once the additives and the body are inside the body processing chamber it is sealed to enable processing to occur. Preferably, potassium is added to the water before it enters the body processing chamber, before sealing the body processing chamber and processing the body. Optionally, the additives and body may be placed into the chamber, before sealing and before the adding the water for processing. Any suitable order may be used instead.

Preferably, water may be received from a first water tank into the body processing chamber for processing, either directly or after heating. Preferably, a solar water heating system is used and water from the clean water tank is used in the solar water heating system to heat it before the water is pumped into the chamber. The water may enter the chamber through the pipe directly or in any suitable manner. Preferably, a water entry point is included in a roof of the chamber. Once the water has entered the chamber he water may be circulated through use of a pump and spray used throughout the process. Most preferably, water is circulated within the chamber during processing. Preferably, a water circulation means is included to circulate the processing water for improved processing during use. Preferably, the circulation means includes a pump arrangement to move water from one location to another. The water circulation means may be housed external or internal to the chamber to cause water circulation within the chamber during processing. The circulated water may be pumped from the base to the top of the chamber. The circulated water may be reintroduced into the chamber or circulated within the chamber. Preferably, a circulation means is used to circulate processing water within the chamber. Preferably, circulated water is sprayed from the top of the chamber on to the body during processing.

Any suitable additive and additive treatment means may be used. The additive may be any suitable material. Preferably, the additive includes Potassium. Preferably, the additive includes or is Potassium Hydroxide. Preferably, Potassium Hydroxide is added of a weight substantially equivalent to 5% of the weight of the body. Most preferably, the weight of the body is determined and substantially 5% of the weight calculated before processing whereby the weight of Potassium Hydroxide added to the body. The adding to the body may take any suitable form. The weighing of the body may be part of the process or a separate step. The weighing of the body and calculating of the weight of the Potassium Hydroxide may be automated through use of the control system.

Most preferably, the additive is introduced using an additive treatment means that does not distribute the additive for processing until the water enters the chamber. Preferably, the additive is added to the water before the water enters the chamber. The additive treatment means may be the addition of the additive to the water. It is appropriate to the sensitivities of the family that any processing additives are kept contained until the processing actually commences. Optionally, an additive may be added direct to the body before placing in the body processing chamber, including by placing an additive treatment means on the body before closing the body in the body processing chamber. In this form of the invention a dissolvable bag may be used. Preferably, the body is contained in the water soluble bag, and the additive treatment means is the introduction of the additive to the water before water enters the body processing chamber. Preferably, in this optional form of the invention the additive is added through use of a substantially dissolvable bag. Preferably, the dissolvable bag is made of a suitable water soluble plastics material. Most preferably, a water-soluble body bag is used to contain the body before processing. Preferably, the bag is made of Polyvinyl Alcohol (“PVA”) with water soluble properties. Preferably, the PVA is of a kind that dissolves in water above 60 degrees Celsius. The bag may dissolve within a few minutes of processing commencing. Preferably, the bag is integral before processing but during processing enables the contents to disperse into the water. Any suitable bag material may be used. Preferably, the bag is made of a biodegradable film. Any suitable biodegradable material may be used for that bag that enables dispersal of the additive at an appropriate time of the processing.

Preferably, substantially 5% of the body weight of Potassium Hydroxide is measured into a dissolvable bag that is put in the chamber with the body, whereby as water enters the chamber the dissolvable bag dissolves and the Potassium Hydroxide enters the water. Preferably, as the Potassium Hydroxide and water mix the pH of the water changes. Preferably, the additive increases the alkalinity of the water. Preferably, the additive and water change the pH of the water to substantially 12-13. Preferably, the additive may be added to the water as it fills the body processing chamber. Any suitable further additive may be added at any suitable time during the process to improve the processing and or facilitate the end result.

Preferably, the water solution from body processing after body processing has been completed is treated to substantially return the water to substantially pH neutral or approximately pH 7.2. Preferably, a food acid is introduced to the water from the body processing. Preferably, a food acid is introduced to the water from the body processing to substantially return the water to a substantially pH neutral or approximately pH 7.2. Preferably, the food acid is chosen from the group: vinegar; citric acid; tartaric acid; folic acid; fumaric acid or lactic acid. Optionally, Carbon Dioxide is introduced to the water slowly until the water is substantially pH 7.2, in an alternative form of the invention. There may be sensors included within the system. The sensors may be for heat, pH or any suitable information it is desired to monitor. Optionally, a pH sensor is included to sense the pH of the water solution. Preferably, the control panel can be used to monitor the information from the sensors. Preferably, controls may be used in response to the sensor readings.

Preferably, some automation is included in the control system. The automation may include automatic feedback to the control system to adjust the heat or pH of the water and different stages of the process. The automation may be in response to the sensor data. There may be automated steps and alerts to the operator to action the next step through the control and monitoring.

Preferably, after body processing the water is completely drained from the chamber to the holding tank, and the chamber flushed with clean water to be clean and dry. At this stage only bones remain in the body basket. Preferably, after processing the water drains to the second tank before being cleaned through the water cleaning system. The second tank may form part of the water cleaning system.

At least one second holding tank may be included. There may be a plurality of holding tanks. Each tank may be included for a different purpose. Preferably, a series of tanks and cleaning processes are included to clean the water from the water solution that leaves the body processing chamber, through to the resultant clean water. The second holding tank may be a 400 litre water tank.

A back wash tank may be included for clean water used to back wash other parts of the system. The back wash tank may be directly filled from the clean water tank or the rain water tank. Mains supply water could be used instead to fill the back wash tank. The back wash tank may be in fluid connection with the clean water side of the system. The back wash tank may be a 300 litre tank, including a top up point to ensure sufficient back wash water supply. Preferably, a pump is used to pump water from the back wash tank to back wash a bag of a bag filtration system. It is through the bag filtration system that a small amount of body nutrient may be removed from the system for the family. Preferably, the control system may operate the back wash system when it is desired to back wash the bag of the bag filtration system.

Preferably, a pump is used to pump water from the second holding tank. Preferably, the pump and or back washing from the second holding tank is controlled by the control system. Preferably, the second holding tank is used to contain the drained water from the processed body including the obtained nutrient. Preferably, the second holding tank water, and contained nutrient from the body are pumped to the bag filter for a first stage of filtering. Preferably, the bag filter is an Amiad bag filtration of a known kind.

Preferably, a water cleaning system is included to clean the water that is captured from the body processing chamber. Preferably, the water cleaning system substantially cleans the water to clean water. Preferably, the water cleaning system cleans the water suitable to be used for irrigation. Preferably, the water cleans the water suitable to be recycled for use in future body processing. Preferably, the clean water is returned to the clean water tank for use in body processing.

Preferably, the water cleaning system includes a bag filtration system. Preferably, the water from the body processing is cleaned through use of a bag filtration system, connected to a back wash tank. Preferably, the majority of the nutrient and particles contained in the processing water are removed through use of the bag filter part of the water cleaning system. Alternative filters may be used instead.

Preferably, a physical filtration system is included in the water cleaning system to thoroughly clean the water. Multiple filters may be used. Physical and chemical filters may be used. The water may be stored as part of the filtration process. Preferably, the sediment produced from the processing is removed from the water solution before water cleaning. The sediment may be used to provide nutrient to plant. The sediment may be settled before being removed. Any suitable means to remove the sediment may be included.

Preferably, the water cleaning system includes a physical filter, a chemical filter and a UV sterilizer to return the processed water to clean water. Preferably, the physical filter is a bag filtration system. Preferably, the bag filtration system enables the sediment from processing to be separated from the water. Preferably, some of the sediment may be used in some way, such as to provide nutrient to a rose plant or tree. Preferably, the processing processes the body of a family member and a sediment pot is used in fluid connection with at least one part of the water cleaning system to remove a small volume of water and or nutrient (sediment) from the processing water for use for the family, such as to grow a plant. Some water may be used with the sediment. Preferably, back wash is achieved to provide a small amount of the water containing water to provide nutrient to a plant to give the family in a safe and convenient manner. Preferably, a sediment pot is used in fluid connection with at least one part of the water cleaning system to remove a small volume of water and or sediment from the processing water. Preferably, the sediment pot is attached to a bag filter with back flush tank.

Preferably, the water cleaning system includes a water filter. The water filter may take any suitable form to act on water resulting from body processing. Preferably, the water cleaning system includes at least one carbon filter. Preferably, the carbon filter removes trace chemicals and particulates from the water from processing. If no bag filter is included the carbon filter used will need to be sufficient to filter the nutrient filled water. Preferably, the bag filter removes the majority of sediment and particulates in the water before the carbon filter is used. The carbon filter may be replaced with any similar water filter suitable to clean the water. Preferably, water flows from the bag filter to the carbon filter for further filtering as part of the water cleaning system. One or more pump may be included at any stage of the water cleaning system if desired to assist the movement of water. Alternatively, electronically controlled valves may be included to assist to move water through the cleaning system as required.

Preferably, the water cleaning system includes a means to act on contaminants in the water. Preferably, the water cleaning system bacteria in the water. Clear water may not be clean water and so it is useful to remove potential contaminants such as bacteria through further filtering. Preferably, an ultraviolet cleaning unit is included in the water cleaning system. A UV sterilizer may optionally be used in some forms of the invention to further remove potential bacteria from the water solution. In other forms of the invention the other parts of the processing are sufficient for sterilising the water. Where a UV sterilizer is used, it may be used to reduce to substantially zero the risk of bacteria in the water. Preferably, water is caused to flow through a bag filter, carbon filter and then a UV sterilizer of the water cleaning system to clean the processing water to clean water. Or the UV sterilizer may be omitted. Testing may occur to determine and certify the exiting water as clean. Preferably, cleaned water is pumped or returned to a clean water tank for further use. Water may also be removed for other uses.

Preferably, a solar heating system is used with the invention to provide heated water. The water may be heated to any suitable temperature. Preferably, one or more heating means or elements are included to further heat the water in the body processing chamber or maintain the temperature of the water received from the solar heating system. In other forms of the invention cold water may be used, and then heated inside the chamber through use of one or more suitable heating elements. Preferably the heating is thermostatically controlled. Preferably, sensors are included in the chamber to detect the temperature in communication with the controls. Preferably, the temperature of the water is controlled from a control panel. Preferably, the temperature is substantially 92 degrees Celsius. Preferably, it has been found substantially 80 degrees Celsius is suitable. Other suitable temperatures may be used.

The processing may be carried out for any suitable length of time. The processing may be carried out for 10 hours, as a time found suitable for body processing to have fully occurred. A shorter time frame can be achieved but it is preferable to process the body slowly and with care.

Preferably, the body processing chamber can be tilted, in one form of the invention. Preferably, in this form of the invention, the body processing chamber may be tilted substantially 45 degrees during processing. Other suitable angles may be used instead. Preferably, the head end of the chamber, or the door end is raised. Preferably, a support/tilt mechanism is used to support and or tilt the chamber from the horizontal. Hydraulics and electronic controls may be included in the support/tilt mechanism to enable lifting so as to tilt from the horizontal. Preferably, the support/tilt mechanism includes an actuated hydraulic control to move from a first state where the chamber is substantially horizontal and a second state where the chamber is substantially tilted. The tilting is useful to assist processing and or drainage away from the head end. In other forms of the invention alternative arrangements may be used including tilting from the feet end. Preferably, the body is put in the body processing chamber, sealed in, and the head end raised to a 45 degree angle toward the feet before addition of the water. Alternative order of use may be used instead.

A tap or outlet point may be included at any suitable point throughout the apparatus. An outlet point may be included at any point of the system after processing to capture nutrient from the body, such as for use to grow a tree or plant to give to the family, and before the water is cleaned. Water solution may be taken off at any suitable part of the system through inclusion of a tap or valve. Likewise clean water may be removed at any suitable point through use of a tap or valve.

Preferably, the body processing apparatus has a low carbon footprint. Preferably, the body processing apparatus is more environmentally friendly than conventional body processing methods. Preferably, the system uses rain water, solar power and recycles the water to be an environmentally friendly means of body processing.

Accordingly, the present invention provides in a variant, a body processing apparatus for treating a dead body, the body processing apparatus including:
two first water tanks for holding water, one being a rain water tank and one being a clean water tank;
a solar water heating system that receives clean water from the clean water tank and heats it,
a body processing chamber including a heating means, the body processing chamber adapted to receive the dead body in a basket, and in fluid connection with the first clean water tank water from the solar heating system, able to receive clean heated water therefrom;
an additive treatment means, whereby necessary Potassium Hydroxide may be added to the body processing chamber to increase the alkalinity of the water before processing, and food acid may be added to the water after body processing to increase the acidity and return the pH of the water to substantially neutral;
at least one second water tank for receiving water from the body processing chamber, through a fluid connection therewith;
a water cleaning system, in fluid connection with the second water tank, including at least one physical filtration unit and a UV treatment unit to substantially clean the water; and
a recycling pipe to take clean water from the water cleaning system to be used in the clean water tank,
   wherein, the body is placed within the body treatment chamber with the Potassium Hydroxide, and hot water enters from the first water tank, and the hot water is kept heated so processing occurs until the body breaks down, food acid is added to return the water to substantially neutral before the water is drained to the second water tank and enters the water cleaning system for cleaning, and once cleaned is returned to the clean water tank for reuse.

Carbon dioxide may be used instead of the food acid in alternative forms of the invention. The recycling of the water may be replaced by the capture of the water for use elsewhere. The human body can produce a large volume of water and for locations where clean water is difficult to obtain, the water creation from the process may be motivation itself to the use the invention. In this form, the nature of the cleaning of the water will be adapted for the use to be made of the water. The reclamation of the water from a processed body without waste is a useful additional benefit of the invention.

Accordingly, the invention also provides a method of body processing using the body processing apparatus the method including the following steps:
a) putting a body in the body processing chamber;
b) sealing the body in the body processing chamber;
c) adding additives and water to the body processing chamber to start the processing of the body by taking the water pH to substantially 12-13;
d) adding acid to the processing water to return the water to substantially neutral pH 7.2
e) draining the processing water from the body processing chamber; and
f) cleaning the drained water to clean water suitable for recycling.

Preferably, the body processing method uses the body processing apparatus of any one or more of the forms identified. The body processing apparatus, may include one or more features of any of the other forms or variants of the invention as described herein.

### INDUSTRIAL APPLICABILITY

The body processing apparatus can be manufactured industrially and supplied for use to specialist service providers.

The invention will now be described in connection with a non-limiting preferred embodiment with reference to the accompanying drawings, in which:

### BRIEF DESCRIPTION OF THE DRAWINGS

FIG. 1 is a side schematic view of a body processing apparatus according to a preferred embodiment of the invention illustrating the water cleaning system and the recycling circuit;

FIG. 2 is a detailed schematic side view of the rain water tank and clean water tank and end of the body processing chamber of FIG. 1;

FIG. 3 is a detailed schematic side view of the body processing chamber of FIG. 1;

FIG. 4 is detailed schematic side view of the holding tank, back wash tank and other end of the body processing chamber of FIG. 1; and

FIG. 5 is a detailed schematic side view of the water cleaning system of FIG. 1 including bag filter, carbon filter and optional UV sanitizer.

### DETAILED DESCRIPTION OF THE INVENTION INCLUDING A BEST MODE

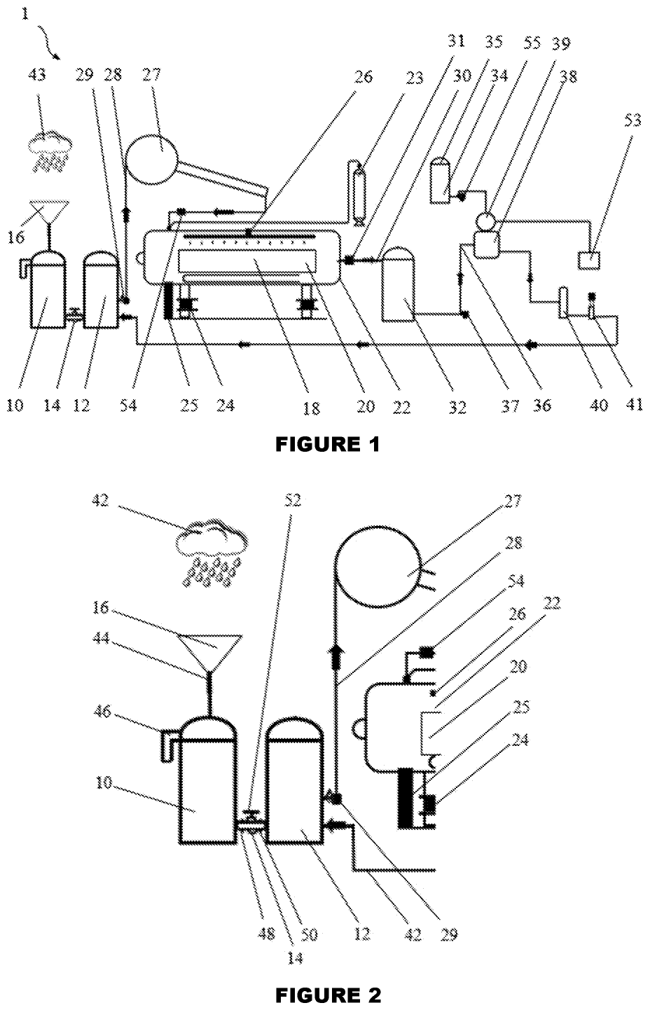

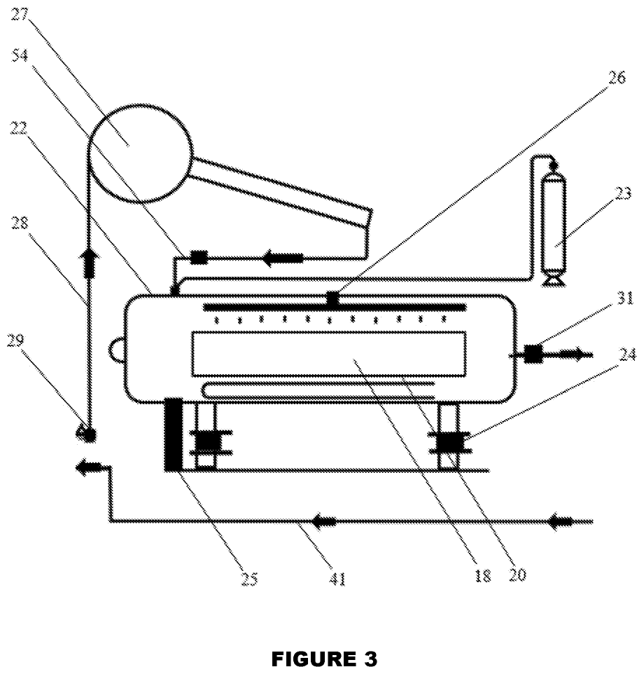

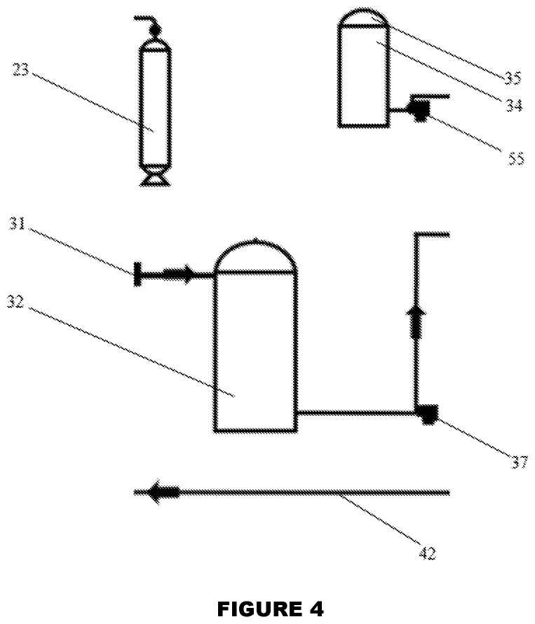

Referring to FIGS. 1 to 5, a preferred embodiment of the invention will be described, where body processing system 1, includes rain water tank 10, clean water tank 12 and valve control 14, which includes 2 valves and a handle to operate. Rain water tank 10 is adapted to collect rain water, such as from a roof, or direct into the tank as shown through use of rain catching system 16. Clean water from the tap could be used, or any other water source. In fact both of these tanks could be omitted in an inferior form of the invention, and mains water could be used, and the clean water resulting from the system could be used elsewhere. However, it is of particular use to include a rain water tank in the system as it adds to the overall recycling, recirculation, and environmentally friendly nature of the process. Further, inclusion of clean water tank 12 enables recycled clean water from the system to be used for future processing, reducing the resources required to run the system, an environmental and cost benefit, in keeping with the intended business model of the inventor. Rain water can be controlled between rain water tank 10 and clean water tank 12 through use of valve control 14 directly manually or by computer control thorough the control panel. As is described elsewhere, the system produces water itself such that the rain water may only be needed to be used initially, or top up clean water tank 12 as required. Use of sparkling clean recycled water, derived from the body from the body processing in the chamber, then cleaned for further processing is one of many advantages to the system.

Clean water tank 12, as illustrated is a standard water tank of 600 litre capacity. Other suitable tanks sizes may be used instead. In the given example, each processing cycle uses 300 litres of clean water. Rain water tank 10 is a 5000 litre capacity tank.

The deceased person, body 18 is treated carefully throughout the process and gently and respectfully put into body basket 20, ready for processing. Body 18 is put into body basket 20 feet first with the head near the door end (not labelled but clearly visible), as shown. Body basket 20 as illustrated is 1900 millimetres long by 740 millimetres wide, suitable to receive most body shapes and sizes. Basket 20 could be a full basket including a top, but this is not necessary and a half-basket shape, open upper most as illustrated is sufficient. Body basket 20 is slid into body processing chamber 22 along reciprocating TEFLON (Trade Mark) coated rails, not shown, which allow easy sliding movement forward and back in and out of body processing chamber 22 of body basket 20. Body processing chamber 22 as shown is 2400 millimetres long and 840 millimetres wide, sized to comfortably receive body basket 20 with sufficient room for the water and additives to circulate for processing. Processing preferably continues for around 10 hours, recirculating the heated water containing the additive for continued, rapid alkaline hydrolysis.

The additive used is Potassium Hydroxide in the given example, and is added by a computer controlled dosing pump of a known form (not shown) and readily mixes with the water before entering the chamber.

Food acid tank 23 is a standard 20 litre drum injected by a dosing pump connection, ready to be used after processing. Food acid tank 23 has a computer controlled valve connection with the top opening of body processing chamber 22. Food acid tank 23 may be connected to feed into the processing water in any suitable manner, at any suitable location.

Support/tilt mechanism 24 including a rocker switch (not shown) and hydraulic lift tilt mechanism 25 is configured to support body processing chamber 22, and move it between the horizontal and a tilted position for use during processing. The tilted position is tilted from the head end to the feet end approximately 45 degree angle from the horizontal. The tilt of 45 degrees is achieved for body processing chamber 22 after body 18 is in position. The tilt feature is optional and may be omitted, in which case the processing is maintained at substantially horizontal. The Potassium Hydroxide introduced with the water is suitable to start the alkaline hydrolysis process. The 45 degree angle is maintained all through the processing until the fluid is drained, and the system is flushed clean. Drainage of the fluid may be assisted through use of the angle, and circulation of water, including through use of water circulation system 26. A spray is included and internal pump to circulate the processing water, to encourage gentle and thorough body processing. Body chamber 22 is returned to horizontal through use of the control system returning tilt mechanism 25 to the horizontal pre-lifted position, after it has been cleaned, so the clean bones may be removed for further processing.

Solar water heating system 27 is used, and may be mounted on the same roof as the roof collection part for rain water tank 10. Solar water heating system 27 as illustrated is a SOLARHART (Trade Mark) system which heats water mounted on a roof through use of the sun and has a storage tank. The 150 litres of heated water, heated through use of solar water heating system 27, is for use in body processing to specifically save the cost to the environment, and the expense of heating the water. Heating water uses a significant amount of power and electric cost, and so warming or heating the water through use of solar heating as part of the system is highly advantageous.

Following the flow of water from clean water tank 12, around the system, water pipe 28 receives clean water pumped by pump 29, up into solar heating system 27. It is intended to keep solar water heating system 27 filled with water and this can occur as part of the maintenance of the system, or on feedback through the control system that as water is taken out of the solar water heating system an equivalent volume of water is pumped by pump 29 along pipe 28 from clean water tank 12 into solar water heating system 27. Therefore, water enters body processing chamber from solar water heating system 27, but when processing is over the water is also removed from body processing chamber 22 through pipe 30 controlled by valve 31 to a so called dirty water tank, holding tank 32. There may be several of these tanks if wished or a single 300 litre tank as illustrated here. Further tank back wash tank 34 with top up point 36 is included. Topping up may be achieved through a separate source of water or from the clean water tank as desired. Back wash tank 34 has clean water used for back washing parts of the system. Pump 37 is electronically controlled to pump water from tank 32 into the next part of the system.

The water that passes into holding tank 32, at this stage includes material from the body removed during processing and so is now passed into water cleaning system 36. Water cleaning system 36 includes bag filtration system 38 with bag 39, carbon filter 40, and optional UV sterilizer 41. Each of these steps is useful to fully clean and sterilize the processed water to clean water to be returned to in return pipe 42 to clean water tank 12. Flocculants may be used, including in a dedicated tank to remove particulates at any suitable part of the system after processing. Likewise, oils and fat residue may be treated such as by use of an enzyme. In this way the circuit is completed with rain cloud 43 indicated to show water entering the system through funnel of rain catching system 16 through rain tank 10, clean water tank 12, solar heating system 27, processing in body chamber 22, passing to holding tank 32 before being cleaned through the steps and stages of water cleaning system 26 so clean, sanitized water can pass through return pipe 42, to clean water tank 12.

Referring to FIG. 2 in particular, overflow 46 of rain tank 10 can be seen which allows for excess rain water to exit rain water tank 10, rather than flood the system in heavy rain. The details of valve 14 with valves 48 and 50 with handle 52 between rain water tank 10 and clean water tank 12 can also be seen. These valves 48, 50 can be opened manually but are also controlled through use of the control system described elsewhere through electronic control to add water to rain water tank 12.

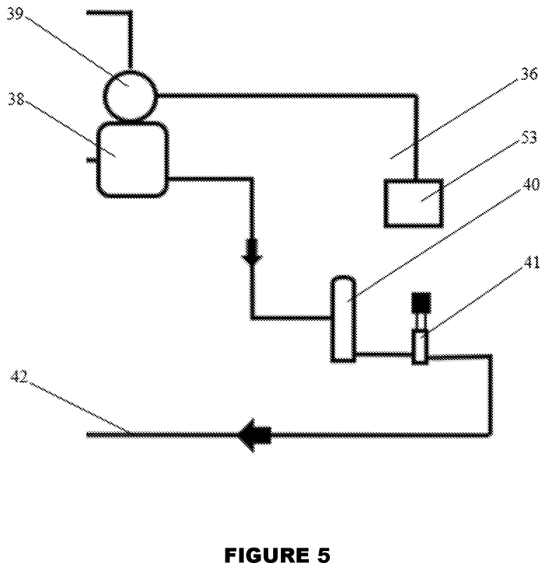

Referring to FIG. 5 in particular, sediment pot 53 can be seen, which also features in FIG. 1. Sediment pot 53 is used in order to capture a small amount of nutrient from the body processing water as sediment and water. Bag filtration system 38 captures the sediment in the most part, and then back wash of clean water from back wash tank 34 into bag 39 captures the small volume of sediment and water, a small cup volume which may be used for a memento for the family. For example, the sediment and water from the body may be used to feed a tree, rose or other suitable plant for the family. The remaining nutrient may be used as fertilizer as appropriate, and treated accordingly if required.

Other features of the system include litre counter 54 included to monitor the litres of water directed form solar heating system 27 into body processing chamber 22. The litre counter data can be accessed in the control system, and may be used to top up the solar water heating system an equivalent volume of water from clean water tank 12. Further pump 55 is included to pump water from back wash tank 34, to back wash bag filtration system 38 with clean water through use of the control system. Manual operation of this and other pumps as well as safety shutoffs are included as required.

A sophisticated control system is included, with a control panel monitor (not shown) on the left-hand side of chamber 22, protruding through the wall to enable the system to be controlled from the front including the body processing chamber 22 manipulation. The control system of the illustrated example is an Allen Bradley Programmable Logic Controller (“PLC”) system of a known form, with a 7 inch display screen, with proprietary software programmed to run the process as supplied by Belmont Electrical http://belmontelectricalproserpine.weebly.com contact belmont9@bigpond.net.au.

After body 18 is in position in body basket 20, within body processing chamber 22 the door is sealed closed. As shown a manual door seal is used, so the door is pushed closed and bar lock (not shown) rotated to compress the door to the opening and seal against the reciprocating seals. An automated door seal and closure may be included instead, in more developed forms of the machine.

Body processing chamber 22 is tilted via the rocker switch and lifting of hydraulic tilt mechanism 25 of support/tilt mechanism 24, to the 45 degree angle by raising the head end. In this way a 45 degree angle is created from the raised head end to the foot end, which rests on the original horizontal plane. Adding of water to body processing chamber 22 will not start until chamber 22 is tilted through use of tilt mechanism 25, and the limit switch of the control system is activated. The steps of operation of the control system following tilt of chamber 22 containing body 18 may be summarised as follows:

STEP 1. Start water pump 29 by operation of water pump on off button on control on control panel (not shown but are of a standard form). Each function as used through the system is operable through use of an on-off switch to electronically actuate the function once the circuit is completed, in the usual manner. Clean water is pumped by pump 29 from clean water tank 12 through 400 litre solar hot water system 27, and stops when litre counter 54 reaches 300 litres. The volume required will depend on the size of the body to be processed and smaller bodies will require the use of less water. Variation to the set water for the litre counter can be made manually or through use of the control system.

STEP 2. Operation of the pH sensor (not shown) within chamber 22 by turning on and monitoring through the control system. The pH of the water in chamber 22 is shown on the monitor, to enable the operator to monitor the pH of the water at any stage, during the processing.

STEP 3. Operation of a submersible heater (not shown) within chamber 22, is by turning on through use of the control panel. Once the submersible heater is turned on, it is pre-set to heat the water and maintain the water at 92 degrees Celsius, once heated. The control system and temperature feedback from temperature sensors (not shown) in chamber 22 enable automated heating and maintanence 3 of the water temperature. Other water temperature settings could be used instead, but 92 degrees Celsius has been found to be particularly efficient for body processing through use of the invention.

STEP 4. Operation of a water circulation pump part of water circulation system 26 (partially shown) within chamber 22 is useful to circulate processing water during the entire processing time. Water circulation is operated through use of the control system and runs for the time limit required according to body weight and or body size. Short processing times are possible with the addition of increased pressure but the design of the system is to be sensitive to the family and treat the body carefully at each step and so a longer process is chosen. Steps 1 to 4 are all controlled by the PLC control and automated, however each function may be stopped or started manually at any point, through use of direct controls on the control panel. Automation of the steps is being refined, and it is envisaged that the process may be full automated from the time of placing the body in the basket, with the timings and flow of water predetermined through program choices made at commencement of operation.

STEP 5. Operation of the control system through the touch screen monitor to the PLC, enables food grade acid gas to be introduced from tank 23, the 20 litre drum for containing the food grade acid, with valve closure and inlet pipe direct into chamber 22. The food grade acid is introduced through electronic control of the opening or closing of a valve which allows or prevents food acid from entering chamber 22 through the pipe. The food acid is introduced direct into the water that has filled the chamber, which reacts to bring the pH of the water closer to neutral. Feedback from the pH sensors to the control enables the operator to manually continue to add acid until the water reaches pH 7.2. An automated feedback system to control the introduction of acid until the pH sensor reflects pH 7.2 is also envisaged. The food acid valve is shut off once the water in chamber 22 reaches 7.2 pH. Manual or other entry points or means may be used instead to introduce the food acid sufficient to return the processing water to substantially neutral.

STEP 6. Operation of the control system empties water from chamber 22 through opening a valve between chamber 22 and pipe 30 manually via PLC to drain the water in chamber 22 through pipe 30 to holding tank 32. Pump 31 is used to pump water into holding tank 32 as required.

STEP 7. The control system is then used, once all the water has been drained into holding tank 32 a back wash of chamber 22 occurs with further clean water from clean water tank 12. Approximately 60 litres of hot clean water is used to back wash and flush chamber 22. The back wash is activated manually via PLC control system to flush chamber 22 clean. The back wash is achieved by flushing a small volume of clean water from clean water tank 12 through the pipe 28, basket 20, chamber 22 and pipe 30 before the back wash is also drained to holding tank 32 after operation. The tilt and 45 degree angle towards the feet end of chamber 22 can be used to assist to drain the water from chamber 22 through the assistance of gravity, once the necessary valves are opened.

STEP 8. The reverse operation of the rocker switch and tilt mechanism 25 enables chamber 22 to be returned to horizontal, now all the water has been drained away. Chamber 22 may be opened through reverse rotation of the bar closure, to unseal the door, and basket 20 slide out of chamber 22 on the sliding rails, to enable access by the operator of the basket contents. The rails are of a known form with a TEFON (Trade Mark) coating to enable very easy sliding in and out, easily achievable by a single operator manually. At this point all of the soft tissues have been processed and all that remains are the bones. These bones may now be removed dried and ‘further processing in a cremulator if desired.

STEP 9. Control and operation of water cleaning system 36 can now be commenced, after processing water from chamber 22 in holding tank 32. The water cleaning system 36 is then activated and the processing water starts moving from tank 32 to the bag filter system an Amiad bag filter system of a known kind. Back wash tank 34 is used to back wash a small amount of water to bag 39 to clean and issue a small cup of nutrient sediment and water to sediment pot 53 for use on a plant to give the family. Further water cleaning then occurs to the water passed through bag filtration 38, passing to carbon filter 40 to further filter chemically the water, then through UV sterilizer 41 to sterilise against potential contaminants in the water. The resulting clear, clean water returned into clean water tank 12 via pipe 42, ready for use once again.

STEP 10. Amiad bag filtration system is back flushed from back wash tank 34 as described elsewhere and drops a quarter of a cup of sediment into sediment collection pot 53 through a 4 second opening of a valve and then placed into a rose bush plant and given to the family. Where a family does not want the plant, the sediment will be placed in our garden area as fertiliser.

The control and PLC and control panel wired to enable activation of the various valves, as well as the functional movement of body processing chamber 22 as described above. Heating is achieved from solar water heating system 27 which provides hot water in an environmentally friendly manner with reduced cost of environmental impact. The entering hot water temperature is controlled through use of the external system in the given example, but it is anticipated that an integrated system may be included to heat the water as it enters the chamber in alternative embodiments. Hot water within body processing chamber 22 is temperature controlled at 92 degrees Celsius through a use of the two submersible heating element (not shown) SCINTEX (Trade Mark) BDIH 2400 w immersion heater with a digital temperature control routed through the PLC of the control system mounted inside body processing chamber 22 and controlled by the PLC.

A 20 kw solar power system (not shown) of a known form is used to provide power to the system as an added benefit, environmentally friendly addition and reduction to the cost and resources used by the system. Reducing the carbon footprint of the process is a great benefit of the system. The solar water heating and solar power system can be integrated, to provide power and or hot water as required.

Body basket 20 is sized 1900 millimetres by 740 millimetres with a hemispherical cross-section, able to contain most body sizes. Body basket 20 is formed of perforated stainless steel. The perforations assist the flow of water during processing, which is useful to fully process all the soft tissues of the body.

Potassium Hydroxide is added in order to increase the alkalinity of the water solution for body processing. The weight of potassium added is calculated to be 5% approximately of the body weight. A little additional may be included to ensure sufficient processing.

Within body processing chamber 22 once body 18 is slide in it is sealed in through the sealed door. The sealed door is strongly sealed to prevent the water solution escaping, including when the water is hot and high pH. Before, water can be caused by the control system to enter chamber 22 an actuator and rocker switch are used to tilt body processing chamber 22 to 45 degrees. Approximately 300 litres of clean water is added to body processing chamber 22 from clean water tank 12. The clean water as illustrated would be rain water from rain water tank 10 for the first use, and then may be recycled water from the system itself as described further below. Topping up of the system may used the cleaned water and or additional rain water. The processing uses 300 litres and the cleaning process and flushing of the various tanks, valves and pipes of the system uses a further 300 litres.

Water circulation system 26 can be seen configured to spray the water received from clean water tank 12 into body processing tank 22 over the entire body 18, in basket 20. The water is hot from the solar water system. The water temperature will depend on the sun action, and may be heated in other ways before being used. While a spray system is particular good at distributing the water and mixing with the additives alternative means to fill chamber 22 may be used instead. The perforations in basket 20 enable water flow about the body to assist in processing. The temperature is raised within body processing chamber 22, using thermostatically controlled elements to 92 degrees Celsius. Once the temperature of 92 degrees Celsius is reached this is maintained for 10 hours, to process the body to bones and a water solution. A time of 10 hours has been found to successfully process the body but this time could be extended or reduced slightly as suitable for the particular processing.

Food acid from tank 23 is added slowly to the water solution from the body processing through a pipe into the chamber. Food acid is added until the water is returned to pH neutral around 7.2. A pH sensor (not shown) is included at the foot end of chamber 22 to detect the pH of the water in the chamber which can be monitored from the display of the control. Food acid is allowed to enter the water from tank 23 through a tube with on off valve slowly, until pH neutral is reached. The controls the pH by controlling the entering and switching off of the food acid feed as it enters slowly into the chamber. Once pH neutral reading is given by the sensor in the chamber, the controller turns off the food acid flow. Once the water solution from the body processing is pH neutral the control panel is used to control the valve arrangements to drain holding tank 32. At this point the water solution is a coffee coloured solution containing nutrients from the processed body, which is drained into holding tank 32 for further processing and cleaning.

The water solution from the body processing contains nutrients derived from the body, and using an AMIAD (Trade Mark) water bag filtration system 38 takes the sediment from holding tank 1, including a back wash and flush water from tank 34 to prevent sediment entering the next stage of the cleaning system. It is advantageous to remove the sediment completely at this stage, and particular before entering the carbon filter. A solenoid is attached to enable release of a small amount of water, after back flushing of the pH neutral water. The sediment and a quarter of a cup of water are then removed through a valve controlled tap (not shown) into a pot used for planting a rose or tree to give to the family after the process is completed. The idea of growing a tree from the nutrients of a body is an ancient one, and this modern processing can still provide that enduring gift to the family.

Return pipe 40 can be seen with direction arrow to run from the outlet of water cleaning system 36 to return the cleaned water to clean water tank 12. It is through the clever use of the water cleaning and filtration system, with carbon filter and UV sterilizer that water from body processing can be cleaned to crystal clear water able to be recycled. The alternative water solution from body processing, is a coffee coloured solution that it would not be desirable to use for other purposes and should not be recycled. The clear water that returns from the processing using the subject invention, is exceptionally clean and so is able to be used for body processing of another person, or for use in irrigation or similar beneficial uses. As the human body is largely made up of water, one of the many benefits of the system is to capture the processed water, filter it clean and then make use of it, rather than need to add more water to the system. Around 60 litres of additional water may be removed from the system per cycle, put through the water cleaning system and be made available for use. Where there is excess water in the system, as this is clear, safe water, this may be removed and used for irrigation, for example, such as on flowers around the buildings housing the apparatus. A mobile water tank can be used to remove the water and take it to where it may best be used. It is anticipated that for some applications the water saving component of the invention will be very highly rated, for example where water sources are very limited or the cost of clean water very high. The water recycling aspect of the invention is an inventive and beneficial aspect in its own right.

The water leaving water cleaning system 36 will be thoroughly filtered, sanitized and made clean, and this will be tested regularly by a certified laboratory to verify the water is suitable for recycling.

Therefore, the method of use of the apparatus may be summarised as capturing water from rain cloud 43, into funnel 44 of rain catching system 16, to flow into rain tank 10, so as to have an environmentally friendly source of free water. Overflow or tap 46 is indicated to cause rain water to leave rain water tank 10. Rain water can be released from rain water tank 10 to clean water tank 12 by use of valve control 14, which includes valves 48 and 50 (to enable independent shut off as required) and manual handle 52 for manual control. Manual or automated control may be used to open and close valve control 14 to enable rain water to enter clean tank 12 from rain water tank 10 so as to have sufficient water in clean tank 12 to perform the body processing, e.g., at least 300 litres.

Although not shown, further valves are present at appropriate junctions between the tanks so that flow of water can be controlled. The control panel again actuates the solenoid valves to enable opening and closing and flow or no flow as desired. Further a safety feature is included that if the system detects no water, running dry that this trips a switch to disable the system. Control of the safety and valves can be both manual and by the PLC.

Basket 20 is slid out of body processing chamber 22, on rails either manually by pulling on a handle or by powered control of the control pane. Once basket 20 is accessible, body 18 can be carefully placed inside, and the reverse slide performed to put body 18 in the chamber. At this point body processing chamber 22 is seal shut through a seal closed through rotation of a three handle spinning wheel, which presses the door closed and sealed firmly. The nature of the door closure ensures effective closing and sealing every time which is important, to prevent inadvertent leaks or spillages. The control panel is accessed at this point to start the heating of the water by turning on the water elements and setting the heat temperature on the thermostat to 92 degrees Celsius.

The control panel is used to operate a support/tilt mechanism 24 and 25 to tilt the chamber to 45 degrees to the horizontal, raised at the head end, draining towards the feet end. Support/tilt mechanism 24 and 25 includes a 24-volt linear actuator manually controlled below the PLC display unit via a rocker switch. It is anticipated that it may be an option to include the control for the tilting in the control system, in later iterations of the system. The tilt mechanism is a standard hydraulics system moving one end between a raised and horizontal state to achieve the 45 degree angle over the chamber from one end to the other.

Approximately 10 hours of the processing is required in order that the soft tissues, skin, muscle and fat are rendered into the water, leaving the bones behind. The water circulation system runs throughout, and the body chamber remains tilted. The control panel can be used once processing is complete to undo the tilt to body processing chamber 22, while acid is added to the resultant water solution to reduce the alkaline solution to neutral, around 7.2 pH. Internal pH sensors are used to detect the pH of the water solution and monitor from the control panel. Clearly some variation to this figure may occur with the size of the body and the heat of the water, as well as the original composition of the clean water and so the acid is introduced very slowly to achieve an accurate pH neutral resultant water, and to not use more acid than necessary.

The water solution from the body processing, with neutral pH is now able to be moved through to holding tanks 32 before water cleaning.

Water cleaning system 36 uses bag filtration system 38 to remove sediment, carbon filter 40 to filter the water and UV sterilizer 41 to sanities potential contaminants from the water. The result is crystal clear water that is also safe and clean to use. The clear, clean water is returned through pipe 42 to water tank 12 for use.

The result of the extensive water cleaning system is that the water is filtered to remove particulates, chemical traces an in UV treated to remove the risk of contaminants. The water as it enters return pipe 40 is crystal clear, and very different to the coffee coloured water containing the broken down flesh of the body, as it enters holding tank 32. The invention provides a thorough cleaning of the water solution to produce clean water suitable for recycling or use. It is possible to process the body quicker, with increased pressure and the accompanying additional energy burden. However, the inventor prefers to have the entire system to be a considered model, sensitive to both the needs of the family and to the environment.

The invention is a significant improvement over the prior art, enabling an economic and environmentally friendly way to respectful process the body. Use of solar generated power, rain water and recycled water dramatically reduces the resources to achieve the processing of the body to bones and water solution, which can then be finally processed for the family.

It will be apparent to a person skilled in the art that changes may be made to the embodiments disclosed herein without departing from the spirit and scope of the invention in its various aspects.

### REFERENCE SIGNS LIST

| | |
|---|---|
| 1 | Body Processing System |
| 10 | Rain water tank |
| 12 | Clean water tank |
| 14 | Valve control (inc. 2 valves + handle) |
| 16 | Rain catching system |
| 18 | Body |
| 20 | Body basket |
| 22 | Body processing chamber |
| 23 | Food acid tank |
| 24 | Support/tilt mechanism |
| 25 | Tilt mechanism |
| 26 | Water Circulation system |
| 27 | Solar water heater system |
| 28 | Pipe |
| 29 | Pump |
| 30 | Pipe |
| 31 | Valve |
| 32 | Holding tank |
| 34 | Back wash tank |
| 35 | Top up point |
| 36 | Water cleaning system |
| 37 | Pump |
| 38 | Bag filtration System |
| 39 | Bag |
| 40 | Carbon Filter |
| 41 | UV Steriliser |
| 42 | Return pipe for clean water |
| 43 | Rain cloud |
| 44 | Funnel |
| 46 | Overflow |
| 48 | Valve to rain tank |
| 50 | Valve to clean water tank |
| 52 | Handle |
| 53 | Sediment pot |
| 54 | Litre counter |
| 55 | Pump |

1-70. (canceled)

71. A body processing apparatus for treating a dead human body, the body processing apparatus including:
at least one first water tank for holding water;
a body processing chamber, for processing the human body by alkaline hydrolysis, the body processing chamber adapted to receive the dead body, and in fluid connection with the first water tank, able to receive water therefrom;
an additive treatment means, whereby necessary additives are added to the body processing chamber or to the water used, during the process, and the additive does not distribute until the water enters the chamber;
at least one second water tank for receiving water from the body processing chamber, through a fluid connection therewith and holding the resultant nutrient and water solution; and
a water cleaning system, in fluid connection with the second water tank to separate the nutrient and water and including a physical filtration system to thoroughly clean the processing water before recycling the substantially clean water, either recirculating within the body processing apparatus, or for another purpose,
wherein, the human body is placed within the body treatment chamber for alkaline hydrolysis processing, additives are added through use of the additive treatment means, water enters from the first water tank and processing occurs until the body breaks down, after which the water is drained to the second water tank, and enters the water cleaning system for a thorough cleaning including being treated to substantially return the water to substantially pH neutral or approximately pH 7.2, ready for recycling or recirculation.

72. The human body processing apparatus of claim 70, wherein a solar power system to provide power is included.

73. The human body processing apparatus of claim 70, wherein a solar water heater system is included to provide hot water and water from the first tank can be used in a solar water heating system and heated before use for body processing in the chamber.

74. The human body processing apparatus of claim 70, wherein a rain water tank is included to supply water to a clean water tank for use in processing.

75. The human body processing apparatus of claim 70, wherein a clean water tank is in fluid connection to a pump, to pump clean water into a solar heating system for heating before use in the chamber for body processing.

76. The human body processing apparatus of claim 70, wherein the additive includes or is Potassium Hydroxide.

77. The human body processing apparatus of claim 76, Potassium Hydroxide is added of a weight substantially equivalent to 5% of the weight of the body.

78. The human body processing apparatus of claim 70, wherein a food acid is introduced to the water from the body processing to substantially return the water to a substantially pH neutral or approximately pH 7.2.

79. The human body processing apparatus of claim 70, wherein after body processing the water is completely drained from the chamber to the holding tank, and the chamber flushed with clean water to be clean and dry.

80. The human body processing apparatus of claim 70, wherein a back wash tank is included for clean water used to back wash other parts of the system.

81. The human body processing apparatus of claim 70, wherein a pump is used to pump water from the back wash tank to back wash a bag of a bag filtration system so a small amount of body nutrient may be removed from the system for the family.

82. The human body processing apparatus of claim 70, wherein the water cleaning system includes a bag filtration system and the majority of the nutrient and particles (sediment) contained in the processing water are removed through use of the bag filter part of the water cleaning system.

83. The human body processing apparatus of claim 70, wherein the processing processes the body of a family member and a sediment pot is used in fluid connection with at least one part of the water cleaning system to remove a small volume of water and or nutrient (sediment) from the processing water for use for the family, such as to grow a plant.

84. The human body processing apparatus of claim 70, wherein the water cleaning system includes a water filter.

85. The human body processing apparatus of claim 70, wherein cleaned water from the water cleaning system is pumped or returned to a clean water tank for further use.

86. The human body processing apparatus of claim 70, wherein one or more heating means or elements are included to further heat the water in the body processing chamber or maintain the temperature of the water received from a solar heating system and the maintained temperature.

87. The human body processing apparatus of claim 70, wherein a water-soluble body bag is used to contain the body before processing.

88. A human body processing apparatus for treating a human dead body, the body processing apparatus including:
two first water tanks for holding water, one being a rain water tank and one being a clean water tank;
a solar water heating system that receives clean water from the clean water tank and heats it,
a body processing chamber including a heating means, the body processing chamber adapted to receive the dead body in a basket and process through alkaline hydrolysis, and in fluid connection with the first clean water tank water from the solar heating system, able to receive clean heated water therefrom;
an additive treatment means, whereby necessary Potassium Hydroxide may be added to the body processing chamber to increase the alkalinity of the water before processing, and food acid may be added to the water after body processing to increase the acidity and return the pH of the water to substantially neutral;
at least one second water tank for receiving water from the body processing chamber, through a fluid connection therewith;
a water cleaning system, in fluid connection with the second water tank, including at least one physical filtration unit to substantially clean the water; and
a recycling pipe to take clean water from the water cleaning system to be used in the clean water tank,
wherein, the body is placed within the body treatment chamber with the Potassium Hydroxide, and hot water enters from the first water tank, and the hot water is kept heated so processing occurs until the body breaks down, food acid is added to return the water to substantially neutral before the water is drained to the second water tank and enters the water cleaning system for cleaning, and once cleaned is returned to the clean water tank for reuse.

89. A body processing apparatus for treating a human body, the body processing apparatus including:
at least one first water tank for holding water;
a body processing chamber, for processing the human body by alkaline hydrolysis, the body processing chamber adapted to receive the dead body, and in fluid connection with the first water tank, able to receive water therefrom;
an additive treatment means, whereby necessary additives are added to the body processing chamber or to the water used, during the process, and the additive does not distribute until the water enters the chamber;
at least one second water tank for receiving water from the body processing chamber, through a fluid connection therewith and holding the resultant nutrient and water solution; and
a water cleaning system, in fluid connection with the second water tank to separate the nutrient and water and including a physical filtration system to thoroughly clean the processing water before recycling the substantially clean water, either recirculating within the body processing apparatus, or for another purpose,
wherein, the human body is placed within the body treatment chamber for alkaline hydrolysis processing, additives are added through use of the additive treatment means, water enters from the first water tank and processing occurs until the body breaks down, after which the water is drained to the second water tank, and enters the water cleaning system for a thorough cleaning including being treated to substantially return the water to substantially pH neutral or approximately pH 7.2, ready for recycling or recirculation, and further wherein a back wash tank is included for clean water used to back wash other parts of the system and a pump is used to pump water from the back wash tank to back wash to a bag of a bag filtration system so a small amount of body nutrient may be removed from the system for the family.
